(19) United States
(12) Patent Application Publication
(10) Pub. No.: US 2008/0302550 A1
(43) Pub. Date: Dec. 11, 2008

(54) Electrical hand-held power tool with a spindle locking device

(75) Inventor: Jochen Erhardt, Klosterlechfeld (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/156,848

(22) Filed: Jun. 4, 2008

(30) Foreign Application Priority Data
Jun. 6, 2007 (DE) 10 2007 000 313.9

(51) Int. Cl. B23Q 5/12; B23Q 5/10

(52) U.S. Cl. 173/216; 173/217

(57) ABSTRACT

An electrical hand-held power tool includes a driving gear wheel (10) connected with the power tool drive motor (6) for transmitting torque from the drive motor (6) to the spindle (12) that drives a working tool holder (18), a spindle locking device (20) located between the driving gear wheel (10) and the spindle (12) for blocking rotation of the spindle (12) and having drive side entrain elements (22) associated with the driving gear wheel (10), driven-side entrain elements (26) associated with the spindle (12), locking bodies (24) arranged between the drive side entrain member (22) and the driven-side entrain member (26), and an annular member (34) in which the locking bodies (24) are rotatably arranged and which is fixedly secured to a power tool housing, and a grease barrier located between the driving gear wheel (10) and the spindle locking device (20).

### BACKGROUND OF THE INVENTION

1. Field of the Invention

The present invention relates to an electrical hand-held power tool including a working tool holder, a spindle for driving, directly or indirectly, the working tool holder, a drive motor for driving the spindle, a driving gear wheel connected with the drive motor for transmitting torque from the drive motor to the spindle, and a spindle locking device located between the driving gear wheel and the spindle for blocking rotation of the spindle. The spindle locking device includes drive side entrain means associated with the driving gear wheel, driven-side entrain elements associated with the spindle, locking bodies arranged between the drive side entrain means and the driven-side entrain elements, and an annular member in which the locking bodies are rotatably arranged and which is fixedly secured to a power tool housing with a working tool-side drive, the locking bodies can be locked between the annular member and the spindle, automatically fixedly securing the spindle relative to the power tool housing.

2. Description of the Prior Art

With the spindle being automatically fixedly secured relatively to the housing in the hand-held power tools of the type discussed above, the working tool, which is received in the working tool holder, can be comfortably removed, in particular with one hand, from the working tool holder, or a new working tool can be inserted in the working tool holder.

German Publication DE 101 48 872 A1 discloses an automatic spindle lock of a motor-driven power tool including a driving gear wheel with axially projecting entrain elements engaging, via roller-shaped locking bodies, projections of a driven member fixedly connected with the spindle for joint rotation therewith. The driven member is so formed that the locking bodies are pressed radially outwardly against a locking surface of an annular member, which is fixedly secured relative to the power tool housing, with a spindle-side drive. Thereby, a locking effect takes place between the annular member and the driven member, resulting in the spindle being fixedly secured.

The drawback of the known power tool consists in that the grease in form of lubrication oil or gear grease travels over the driving gear wheel to the spindle lock. There, the grease can lead to gluing of the locking bodies that can result in the spindle lock malfunction both with a motor-side drive and a working tool-side drive.

Accordingly, an object of the present invention is to provide a power tool of the type discussed above in which a stable function of the spindle lock is insured.

### SUMMARY OF THE INVENTION

These and other objects of the present invention, which will become apparent hereinafter, are achieved by providing, in a power tool described above, a grease barrier located between the driving gear wheel and the spindle locking device. The grease barrier reduces the transportation of the grease, which is used in the region of the driving gear, to the spindle locking device, at least to such mass that can insure a reliable function of the spindle locking device.

According to an advantageous embodiment of the present invention the grease barrier includes an annular disc arranged on an end surface of the driving gear wheel adjacent to the spindle locking device at a radial height of a toothing of the driving gear wheel. Thereby, the transportation of the grease to the spindle locking device over the toothing of the driving gear wheel is effectively blocked, and such grease barrier can be produced particularly easy.

Preferably, the annular disc extends radially over the entire height of the toothing of the driving gear wheel. Thereby, the transportation of the grease along the toothing of the driving gear wheel can be reliably prevented even at a very long duration of the power tool operation.

Advantageously, the annular disc is frictionally or formlockingly connected with the driving gear wheel. In this case, the annular disc functions as a Hager disc with which the grease on the driving gear wheel, which is transported form the driving gear wheel in the direction of the spindle locking device, is displaced radially outwardly and is carried away from the spindle locking device.

Advantageously, the end surface of the driving gear wheel is formed as a convexly curved surface, and the locking body is roller-shaped and is guided over the convexly curved surface. Thereby, even in case the grease appears on the convexly-curved surface of the driving gear wheel, which is adjacent to the spindle locking device, the danger of gluing of the locking bodies on that surface is noticeably reduced because the bodies form actually only a linear contact region with the end surface.

Advantageously, the convexly curved surface circumferentially supports the annular disc. Thereby, the convexly curved surface additionally takes on the function of centering and supporting the annular disk. This makes possible a compact and cost-effective formation of the grease barrier.

It is particular advantageous, when the driving gear wheel is rotatably supported on the spindle, and a sealing ring is provided between the driving gear wheel and the spindle. Thereby, the transportation of the grease, which is accumulated between the spindle and the driving gear wheel supported thereon, in the direction of the spindle locking device is reliably prevented.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional view of a working tool-side portion of a hand-held power tool according to the present invention;

FIG. 2 a cross-sectional view of a spindle locking device of the hand-held tool shown in FIG. 1 along line II-II;

FIG. 3 a perspective exploded view of the spindle locking device shown in FIG. 2; and

FIG. 4 a cross-sectional view of detail IV in FIG. 1 at an increased, in comparison with FIG. 1, scale.

### DETAILED DESCRIPTION OF THE PREFERRED EMBODIMENT

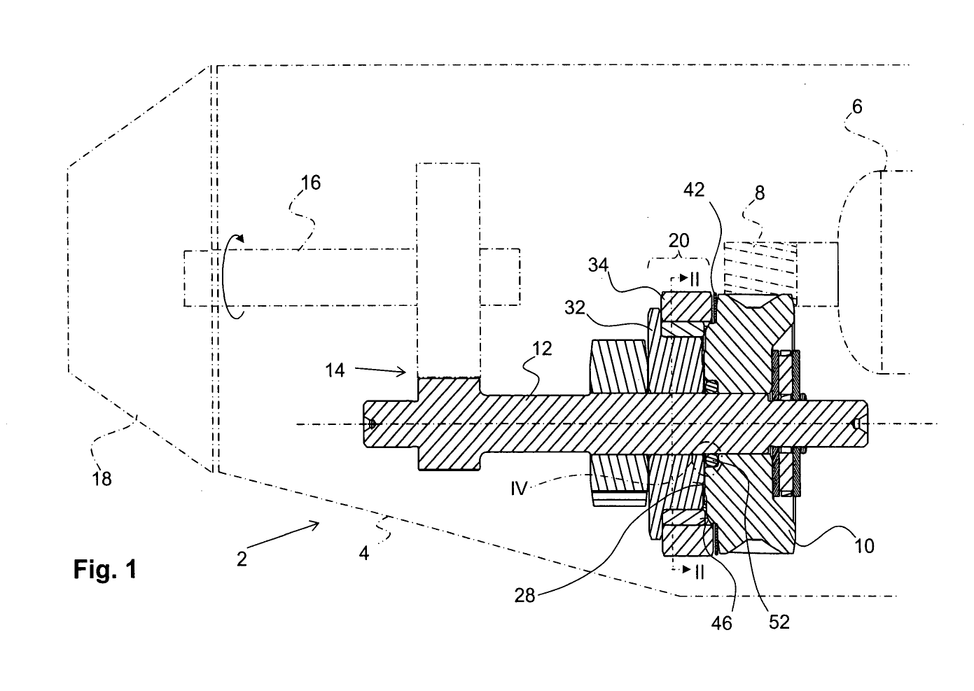

A hand-held power tool 2 according to the present invention such as, e.g., a percussion drilling tool, a working tool-side portion of which is shown in FIG. 1, includes a housing 4 and a drive motor 6 located in the housing 4 and having a drive pinion 8 that a driving gear wheel 10 engages. The driving gear wheel 10 is rotatably supported on a forward-extending shaft that serves as a spindle 12 rotatable about axis A. A gear unit 14 connects the spindle 12 with a driven shaft 16 on which a tool holder 18 is secured, whereby a torque is transmitted from the spidle 12 to the shaft 16. A spindle locking device, which is generally designated with a reference numeral 20, is arranged between the driving gear wheel 10 and the spindle 12.

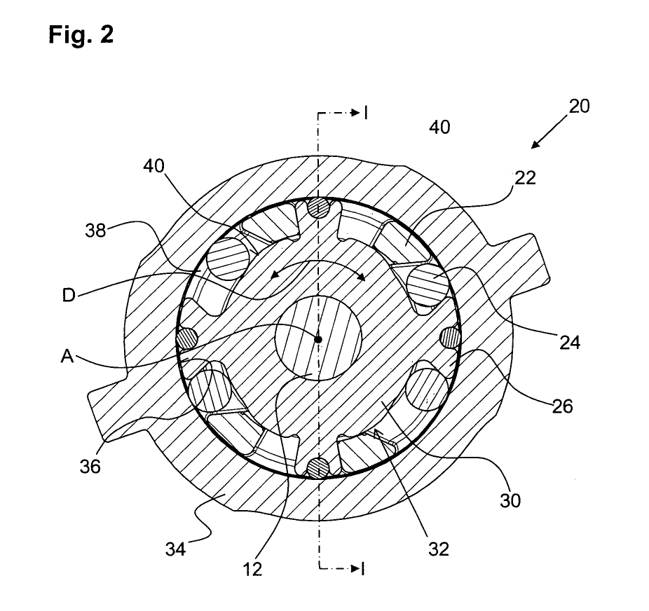

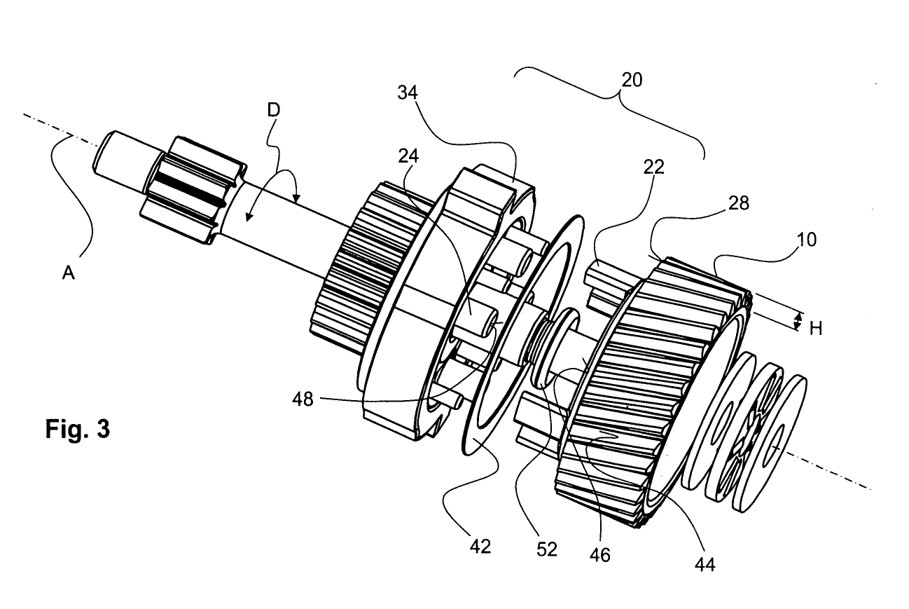

As shown in FIGS. 2-3, the spindle locking device 20 has a plurality of drive side entrain elements 22 which engage, in a rotational direction D about an axis A, directly on one side and indirectly on another side, via roller-shaped locking bodies 24, driven-side entrain elements 26. The drive side entrain elements 22 are formed by claw-shaped elements which project axially, with respect to the axis A, from an end side 28 of the driving gear wheel 10 adjacent to the spindle locking device 20, as particularly shown in FIG. 3.

The driven-side entrain elements 26, as shown in FIG. 2, are also formed as claw-shaped elements which project radially from an annular body 30 of a driven member 32 mounted on the spindle 12 for joint rotation therewith. The driven member 32 is rotatably held in an annular member 34 fixedly secured in the housing 4.

The annular member 34 has a cylindrical inner wall 36 that, together with the driven member 32, radially limit a plurality of receiving chambers 38 for the locking bodies 24. To this end, the driven member 32 is provided with a plurality of locking surfaces 40 that are spaced from the inner wall 36 in the rotational direction D by changing radial distances.

In this way, the drive side entrain elements 22, the locking bodies 24, and the driven member 32 can rotate together with the spindle 12, about the axis A when a necessary torque is applied from the motor 6 to the drive entrain elements 22.

However, when the torque is applied sidewise from the working tool holder 18, the locking bodies 24 are clamped between the inner wall 36 and the locking surfaces 40, blocking the rotation of the driven member 32 with the spindle 12.

As further shown in FIG. 3, between the driving gear 10 and the spindle locking device 20, an annular disc 42 is arranged that extends in the radial direction on the end side 28 completely over a tooth height H of a toothing 44 of the driving wheel 10.

The annular disc 42 is centered by a convexly curved surface 46 and is supported radially by means provided on the end side 28 of the driving gear wheel 10. The opening in the annular disc 42 can be so dimensioned that between the disc 42 and the driving gear wheel 10, a locking action and, thus, a joint rotational connection is produced. Alternatively to that, to provide for a joint rotational connection between the driving gear wheel 10 and the annular disc 42, it is possible to form a formlocking connection (not shown) effective in the rotational direction. In both cases, the annular disc 42 acts as a Hager disc.

Simultaneously, the convexly curved surface 46 functions as a side guide for the locking bodies 24. The convexly curved shape of the surface 46 provides, together with respective drive side end surfaces 48 of the locking bodies 24, for formation of a point or linear contact region.

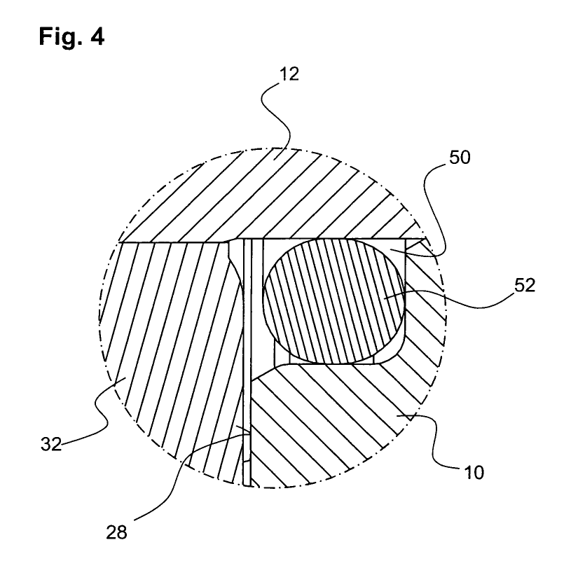

Further, as shown in FIGS. 1 and 4, there is provided on the end surface 28, an annular receptacle 50 for receiving a sealing ring 52 arranged between the spindle 12 and the driving wheel 10.

During operation, the annular disc 42, the convexly curved surface 46, and the sealing ring 52 form together a grease barrier that prevents a damaging penetration of grease in the spindle locking device 20, with the grease being retained in the region of the driving gear 10.

The annular disc 42 blocks entry of grease that is transported over the toothing 44 in the direction of the spindle locking device 20, and the sealing ring 52 blocks entry of grease that creeps between the driving wheel 10 and the spindle 12 in the direction of the spindle locking device 20. Furthermore, the point or linear contact regions of the locking bodies 24 and the end surface 28 made possible by the convexly curved shape of the surface 46, prevent, as a result of gluing of the locking bodies, the danger of malfunction of the spindle locking device 20 even when grease has penetrated.

Though the present invention was shown and described with references to the preferred embodiment, such are merely illustrative of the present invention and are not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. An electrical hand-held power tool (2), comprising:
a working tool holder (18);
a spindle (12) for driving the working tool holder (18);
a drive motor (6) for driving the spindle (12);
a driving gear wheel (10) connected with the drive motor (6) for transmitting torque from the drive motor (6) to the spindle (12);
a spindle locking device (20) located between the driving gear wheel (10) and the spindle (12) for blocking rotation of the spindle (12) and having drive side entrain means (22) associated with the driving gear wheel (10), driven-side entrain means (26) associated with the spindle (12), locking bodies (24) arranged between the drive side entrain member (22) and the driven-side entrain member (26), and an annular member (34) in which the locking bodies (24) are rotatably arranged and which is fixedly secured to a power tool housing; and
a grease barrier located between the driving gear wheel (10) and the spindle locking device (20).

2. An electrical hand-held power tool according to claim 1, wherein the grease barrier comprises an annular disc (42) arranged on an end surface (28) of the driving gear wheel (10) adjacent to the spindle locking device (20) at a radial height of a toothing (44) of the driving gear wheel (10).

3. An electrical hand-held power tool according to claim 2, wherein the annular disc (42) extends radially over an entire tooth height (H) of the toothing (44) of the driving gear wheel (10).

4. An electrical hand-held power tool according to claim 2, wherein the annular disc (42) is connected with the driving gear wheel (10) for joint rotation therewith.

5. An electrical hand-held power tool according to claim 1, wherein the end surface (28) of the driving gear wheel (10) has a convexly curved surface (46), and wherein the locking body (24) are roller-shaped and are guided over the convexly curved surface (46).

6. An electrical hand-held power tool according to claim 5, wherein the convexly curved surface (46) circumferentially supports the annular disc (42).

7. An electrical hand-held power tool according to claim 1, wherein the driving gear wheel (10) is rotatably supported on the spindle (12), and wherein a sealing ring (52) is provided between the driving gear wheel (10) and the spindle (12).
